(19) United States
(12) Patent Application Publication
(10) Pub. No.: US 2017/0219531 A1
(43) Pub. Date: Aug. 3, 2017

(54) ULTRASONIC TESTING SYSTEMS HAVING ADJUSTABLE ARRAYS AND ASSOCIATED METHODS OF USE AND MANUFACTURE

(71) Applicant: Pulse Manufacturing LLC d/b/a Advanced Material Solutions, Inc., Phoenix, AZ (US)

(72) Inventors: Dale E. Thorpe, Goodyear, AZ (US); Peter Edward Miller, Phoenix, AZ (US); Charles Robert Walters, JR., Phoenix, AZ (US); Christopher Allen Bewsey, Mesa, AZ (US)

(21) Appl. No.: 15/421,736

(22) Filed: Feb. 1, 2017

Related U.S. Application Data
(60) Provisional application No. 62/290,348, filed on Feb. 2, 2016.

(51) Int. Cl. G01N 29/22

(52) U.S. Cl. CPC G01N 29/225

(57) ABSTRACT

Various embodiments of ultrasonic testing systems are disclosed herein. In one embodiment, an ultrasonic testing system includes a plurality of ultrasonic arrays. The individual ultrasonic arrays include a transducer support extending along a length of the corresponding ultrasonic array, and a plurality of ultrasonic transducers. The individual ultrasonic transducers are mounted to the corresponding transducer supports, and are operable to generate ultrasonic sound waves. The system also includes an adjustable mount supporting the plurality of ultrasonic arrays and operable to adjust a position of the plurality of ultrasonic arrays along two non-parallel axes.

### CROSS-REFERENCE TO RELATED APPLICATION

The present application claims the benefit of and priority under 35 U.S.C. §119(e) to U.S. Provisional Patent Application No. 62/290,348, filed Feb. 2, 2016, which is incorporated herein by reference in its entirety.

### TECHNICAL Field

The present technology relates generally to ultrasonic testing systems and, more particularly, to ultrasonic testing systems having one or more transducer arrays that are adjustable to accommodate test objects of varying sizes and shapes.

### BACKGROUND

A variety of nondestructive testing systems have been employed to detect flaws in manufactured parts or components. For example, ultrasonic testing systems are often used to detect flaws in munition components and vehicle components. Many of these testing systems are designed to accommodate and test particular components having a particular size and shape. Although these systems can provide accurate tests of the components for which they are designed, they often provide inadequate results when testing other components having different sizes, shapes, materials, etc. To ensure accurate analyses of components having varied sizes and shapes, multiple testing systems are often employed, with each testing system tailored to a particular component. While this can provide an accurate analysis for each component, the design and construction of each tailored test system can involve significant expense.

Additionally, although some testing systems have been designed to accommodate test objects having different sizes and shapes, these systems generally produce less accurate analyses. Specifically, existing nondestructive testing systems that provide the flexibility of handling components of varying shapes and sizes often sacrifice accuracy for flexibility, and lack the accuracy of custom-tailored test systems. Accordingly, it would be advantageous to provide a nondestructive test system that could provide the accurate analysis available via a custom-tailored system, while also providing for the testing of components having varied sizes and shapes.

### BRIEF DESCRIPTION OF THE DRAWINGS

FIG. 1 is a top rear isometric view of an ultrasonic testing system configured in accordance with an embodiment of the present technology.

FIG. 2 is a top front isometric view of the ultrasonic testing system configured in accordance with an embodiment of the present technology.

FIG. 3 is an end isometric view of the ultrasonic testing system configured in accordance with an embodiment of the present technology.

FIG. 4 is an isometric view of a portion of an array mount and several ultrasonic arrays configured in accordance with an embodiment of the present technology.

FIGS. 5A and 5B are side views of ultrasonic arrays configured in accordance with embodiments of the present technology.

FIG. 6 is a partially schematic isometric view of the an ultrasonic testing system configured in accordance with an embodiment of the present technology.

### DETAILED DESCRIPTION

The present technology describes various embodiments of ultrasonic testing systems having one or more adjustable arrays for testing components or devices. In one embodiment, for example, an ultrasonic testing system includes a plurality of ultrasonic arrays. The individual ultrasonic arrays include corresponding supports, and a plurality of ultrasonic transducers are positionable at a variety of positions on the supports. The ultrasonic testing system can also include an adjustable array mount that is operable to adjust the position of the plurality of arrays along at least two axes.

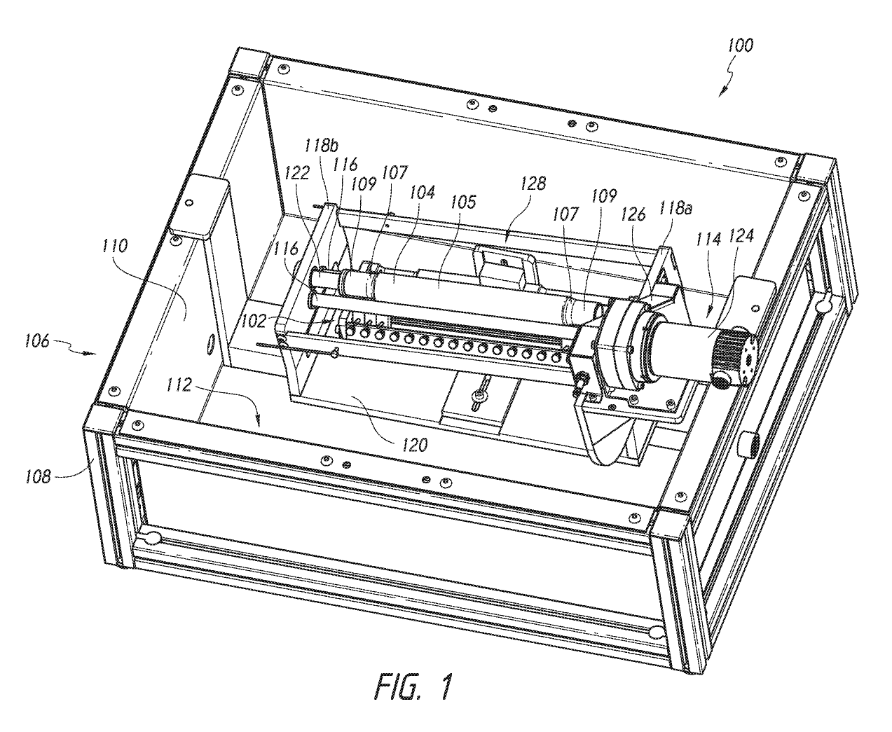

Certain details are set forth in the following description and in FIGS. 1-6 to provide a thorough understanding of various embodiments of the present technology. Other details describing well-known structures and systems often associated with ultrasonic testing systems, transducers, transducer arrays, electronic controls, etc. have not been set forth in the following disclosure to avoid unnecessarily obscuring the description of the various embodiments of the present technology.

Many of the details, dimensions, angles and other features shown in the Figures are merely illustrative of particular embodiments of the present technology. Accordingly, other embodiments can add other details, dimensions, angles and features without departing from the spirit or scope of the present invention. In addition, those of ordinary skill in the art will appreciate that further embodiments of the invention can be practiced without several of the details described below.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1 is a top rear isometric view of an ultrasonic testing system (UTS) 100 configured in accordance with an embodiment of the present technology. The UTS 100 can include a plurality of ultrasonic arrays 102 (only one ultrasonic array is visible in FIG. 1) positioned to direct ultrasonic sound waves at a test object 104 (e.g., a vehicle component or munition component) and receive ultrasonic sound waves that have been reflected and/or refracted by the test object 104. In the illustrated embodiment, the test object 104 is an airbag inflator that includes a uniformly cylindrical central portion 105, a pair of tapered transition portions 107, and a pair of uniformly cylindrical end portions 109. As described in more detail below, the ultrasonic arrays 102 and associated transducers can be positioned such that sound waves from the transducers impinge the test object 104 at desired locations and at desired angles to non-destructively test the integrity of the test object 104.

The UTS 100 includes a test box 106 having a frame 108. The frame 108 supports a body 110 that defines a testing pool 112. Water or other liquid can be added to the testing pool 112, and the test object 104 and several components of the UTS 100 (e.g., the arrays 102) can be submerged within the testing pool 112 during ultrasonic testing. The UTS 100 also includes a rotatable support system or subsystem 114 that can support and rotate the test object 104. The rotatable support system 114 includes a pair of rollers 116 extending between a first support wall 118a and a second support wall 118b (referred to collectively as support walls 118). The support walls 118 extend from opposing ends of a base 120, and a rotatable guide 122 extends through the second support wall 118b to rotatably engage the test object 104. A motor 124 is operably coupled to the rollers 116 via a drive mechanism 126 that is attached to the first support wall 118a. As described in more detail below, the motor 124 can drive the rollers 116 to rotate, and the rotation of the rollers 116 can rotate the test object 104 and the rotatable guide 122 about a longitudinal axis of the test object 104. The UTS 100 can further include an adjustable array mount 128 that is movable (e.g., translationally movable) about multiple axes to position the arrays 102 at a variety of positions with respect to the test object 104.

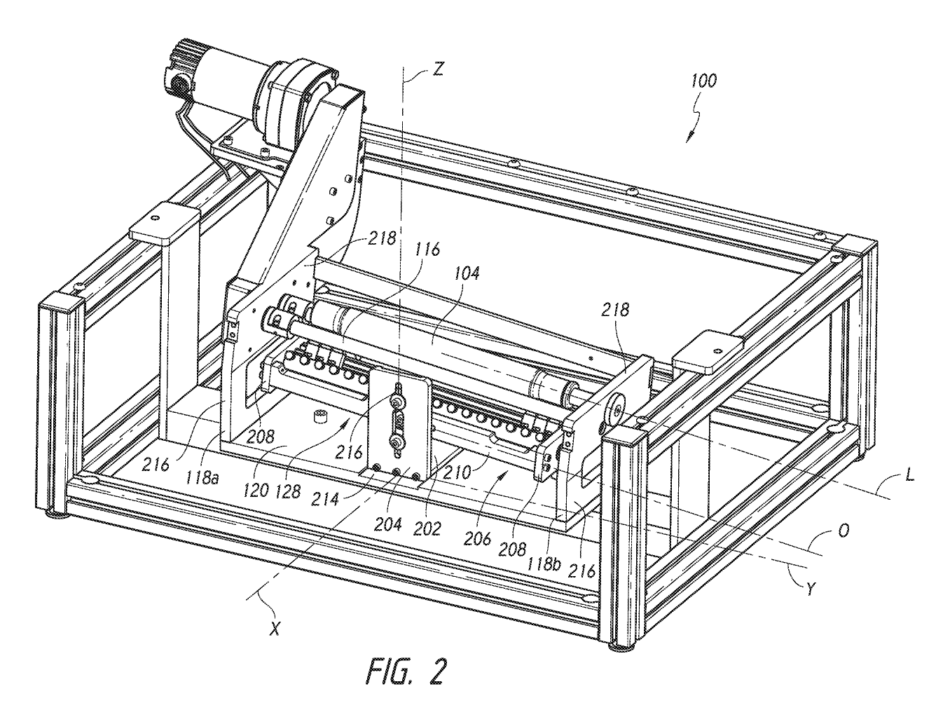

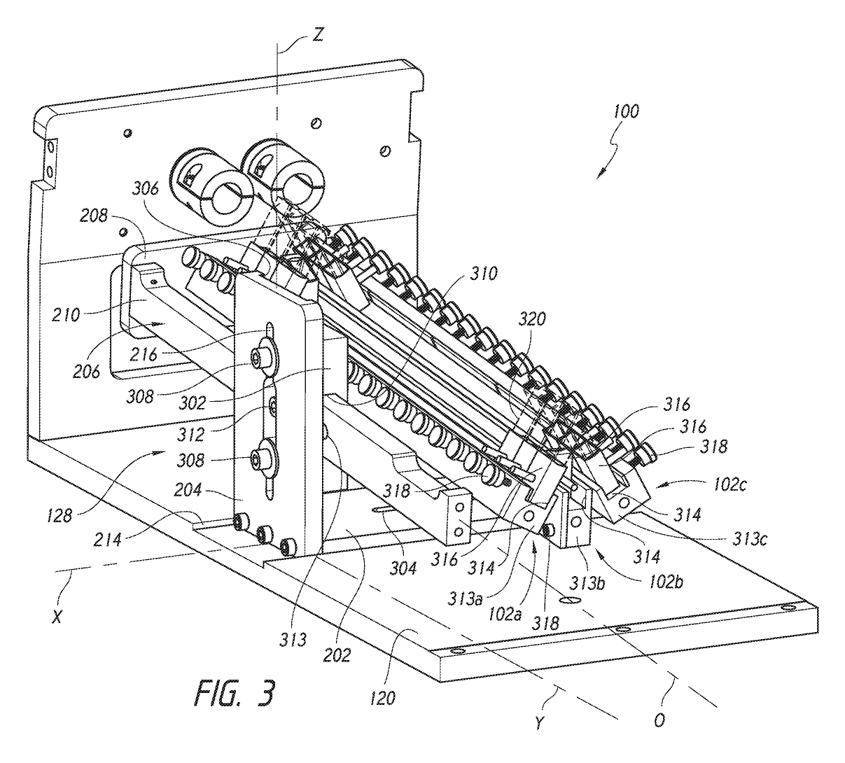

FIG. 2 is a top front isometric view of a portion of the UTS 100 configured in accordance with an embodiment of the present technology, and FIG. 3 is an end isometric view of a portion of the UTS 100 configured in accordance with an embodiment of the present technology, and with the test object 104 removed for illustration. In the illustrated embodiments of FIGS. 2 and 3, several components of the UTS 100 have been removed for clarity. For example, the body 110 and portions of the frame 108 (shown in FIG. 1) are not shown in FIGS. 2 and 3 to better illustrate other components of the UTS 100. Referring to FIGS. 2 and 3 together, the array mount 128 includes a first guide plate (e.g., a horizontal guide plate 202), a second guide plated (e.g., a vertical guide plate 204), a mounting block 302, and an array clamp 206 having a pair of end plates 208 fastened at opposite ends of a mounting bar 210. The horizontal guide plate 202, the vertical guide plate 204, and the mounting bar 210 include slots that enable these components to be fastened to corresponding components in a variety of positions. For example, the horizontal guide plate 202 includes a slot 304. A fastener (not visible in FIGS. 2 and 3) can extend through the slot 304 to secure the horizontal guide plate 202 to the base 120. In particular, the horizontal guide plate 202 can be moved to a variety of positions along a first horizontal axis X within a channel 214 in the base 120, and then secured at a desired position via the fastener extending through the slot 304 into the base 120.

The vertical guide plate 204 is coupled to the horizontal guide plate 202 and includes a slot 216 and a channel 306. The slot 216 and the channel 306 enable positioning of the mounting block 302 along a vertical axis Z. In particular, the mounting block 302 can be moved along the vertical axis Z within the channel 306, and fasteners 308 can extend through the slot 216 in the vertical guide plate 204 to secure the mounting block 302 at a desired position along the vertical axis Z.

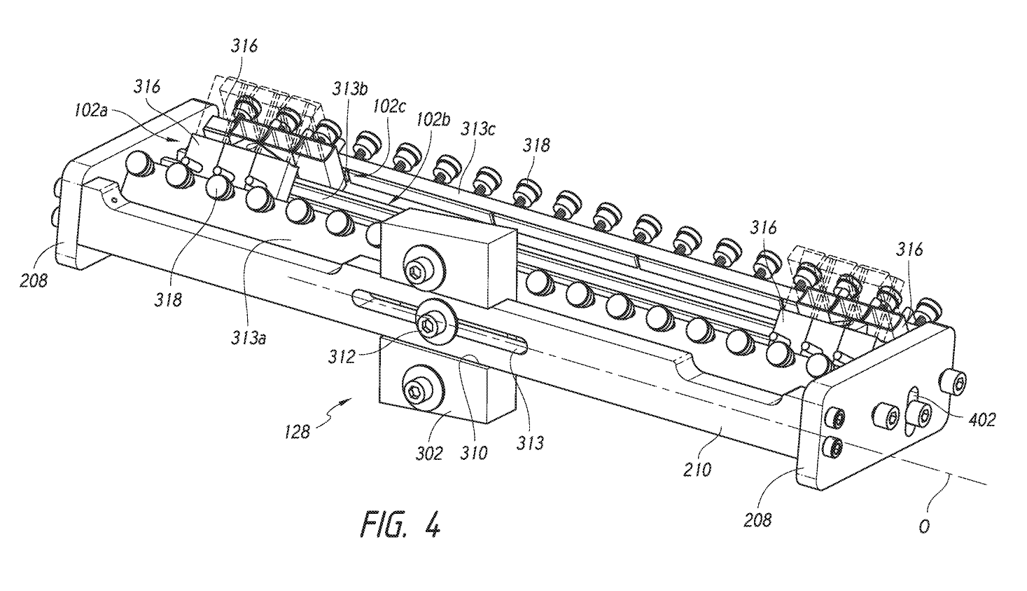

FIG. 4 is an isometric view of a portion of the array mount 128 and the ultrasonic arrays 102 configured in accordance with an embodiment of the present technology. Referring to FIGS. 3 and 4 together, the mounting block 302 includes a channel 310. The mounting bar 210 extends through the channel 310 and can be secured at a variety of positions along an oblique axis 0 via a fastener 312 extending through the slot 216 of the vertical guide plate 204 and also extending through a slot 313 in the mounting bar 210. The end plates 208 are coupled to the mounting bar 210, and the ultrasonic arrays 102 are coupled to the end plates 208.

The ultrasonic arrays 102 (identified individually as a first ultrasonic array 102a, a second ultrasonic array 102b, and a third ultrasonic array 102c) include corresponding transducer supports 313 (identified individually as a first transducer support 313a, a second transducer support 313b, and a third transducer support 313c). The transducer supports 313 can include corresponding transducer mounts 314 (e.g., channels). Each of the arrays 102 can include one or more transducers 316 that are positionable along axes parallel to the oblique axis O within one of the corresponding channels or mounts 314. In particular, each of the transducers 316 can be independently moved within one of the corresponding mounts 314 and secured in a desired position via fasteners 318 (e.g., screws). In the illustrated embodiment of FIGS. 3 and 4, the mounts 314 are channels. In other embodiments, the mounts 314 can be rails, and the transducers 316 can include grooves that match the rails such that the transducers 316 can be mounted to the rails. In other embodiments, the ultrasonic arrays 102 can include other mechanisms or components to mount the transducers 316 at a desired position along a length of the corresponding support 313. As described in more detail below, the transducers 316 can be constructed to emit ultrasonic sound waves 320 (shown schematically in FIG. 3) at a variety of angles.

As shown in FIG. 2, the support walls 118 include lower portions 216 that are parallel to the vertical axis Z, and upper portions 218 that are angled forward relative to the X axis with respect to the lower portions 216. The rollers 116 are operably coupled to the upper portions 218, and the rollers 116 thereby extend at an oblique angle with respect to the second horizontal axis Y. Accordingly, a longitudinal axis L of the test object 104, which rests on the rollers 116, also extends at an oblique angle with respect to the second horizontal axis Y. In several embodiments, the array mount 128 can be constructed to align a longitudinal axis of the arrays 102 with the longitudinal axis L of the test object 104. For example, referring to FIGS. 2-4, the channel 310 in the mounting block 302 provides for positioning of the mounting bar 210 in parallel alignment with the test object 104 such that the longitudinal axis L is parallel to the oblique axis O. In other embodiments, the channel 310 can be constructed to position the mounting bar at a variety of other angles.

In the illustrated embodiment of FIG. 4, the second ultrasonic array 102b is independently adjustable. In particular, the end plates 208 include Z axis slots 402 (only one visible in FIG. 4), and the second transducer support 313b is fastened to the endplates 208 via fasteners that extend through the slots 402. The slots 402 provide for adjustment of the second ultrasonic array 102b to position the associated transducers 316 at a variety of distances from the test object 104 (FIG. 1). Although the illustrated embodiment of FIG. 4 includes slots 402 positioned for securing the second transducer support 313b, in other embodiments, the end plates 208 can include additional slots 402 that can extend in the Z axis or other directions to adjust the position of the first ultrasonic array 102a, the second ultrasonic array 102b, and/or the third ultrasonic array 102c in one or more directions.

Referring to FIGS. 1-4 together, in operation the UTS 100 can perform non-destructive testing on the test object 104 by directing ultrasonic sound waves at the test object 104 and analyzing the ultrasonic sound waves that are reflected and/or refracted off of the test object 104 to detect flaws, imperfections, or other anomalies of the test object 104. To begin, the test object 104 is placed on the rollers 106 and engaged with the rotatable guide 122. The test box 106 is then filled with liquid (e.g., water), and the motor 124 is energized to rotate the test object 104 via the rollers 106. The ultrasonic transducers 316 are energized to direct ultrasonic sound waves through the water to the test object 104. The ultrasonic sound waves impinge the test object 104 and are reflected and/or refracted by the test object 104. At least some of the reflected and/or refracted sound waves travel to one or more of the transducers 316. In response to receiving sound waves, the transducers 316 generate electrical signals. As described in more detail below, the electrical signals can be analyzed to detect flaws such as structural defects (e.g., cracks) within the test object 104.

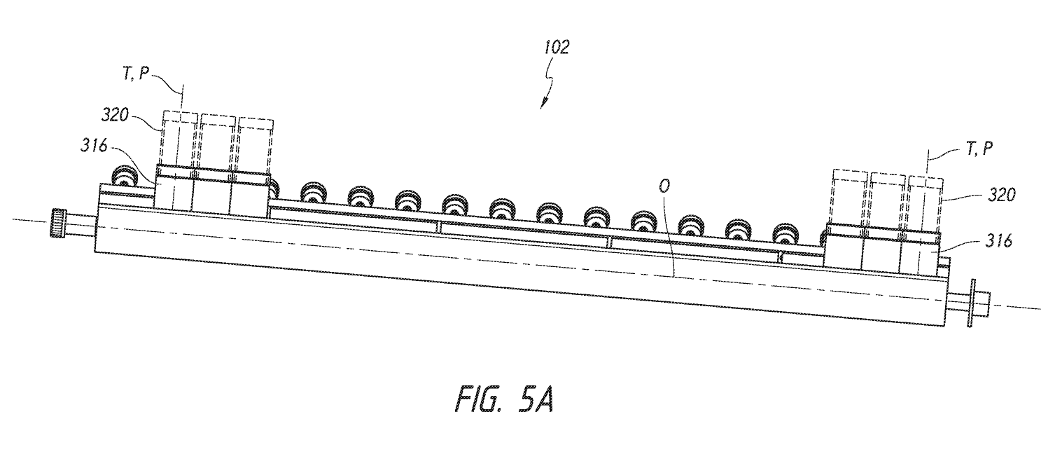

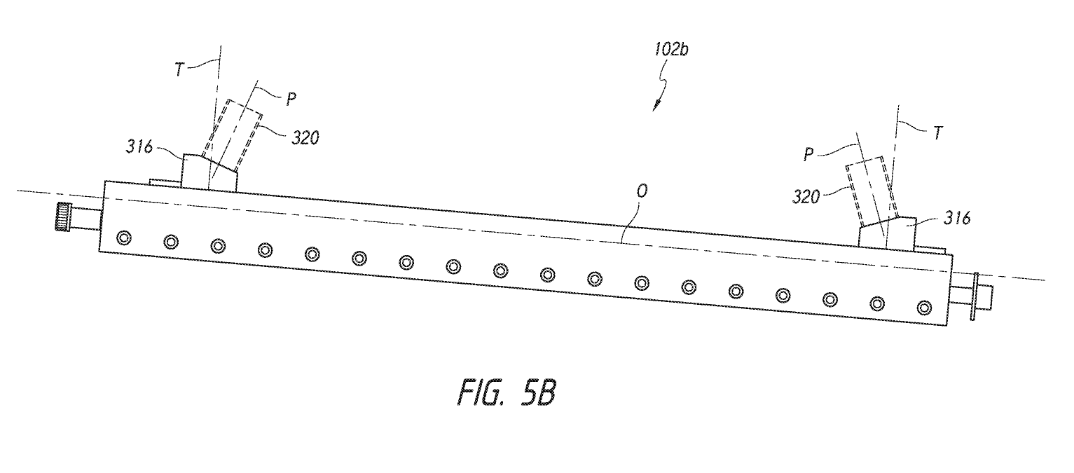

FIGS. 5A and 5B are side views of the third ultrasonic array 102c and the second ultrasonic array 102b, respectively, configured in accordance with embodiments of the present technology. In the illustrated embodiment of FIG. 5A, the third ultrasonic array 102c includes multiple transducers 316. The transducers 316 are positioned to extend along transducer axes T that are normal to the oblique axis O. Additionally, the transducers 316 are constructed to emit sound waves 320 in the direction of a projection axis P that is parallel to the transducer axes P. Referring to FIGS. 2 and 5A, the sound waves 320 emitted from the transducers 316 on the third ultrasonic array 102c interact with the uniform end portions 109 of the test object 104. In particular, the emitted sound waves 320 can impact the uniform end portions 109 at a perpendicular angle to a surface of the test object 104.

In the illustrated embodiment of FIG. 5B, the second ultrasonic array 102b includes two transducers 316. The transducers 316 are positioned to extend along transducer axes T that are normal to the oblique axis O. However, the transducers 316 are constructed to emit sound waves 320 in the direction of a projection axis P that is at an oblique angle with respect to the transducer axes T. Referring to FIGS. 2 and 5B, the projection axis P can be selected such that the transducers 316 on the array 102b emit sound waves 320 that impact the transition portions 107 at a perpendicular angle to the surface of the test object 104. For example, in several embodiments, a variety of transducers 316 can be constructed to emit sound waves 320 at a variety of angles with respect to the transducer axes T. Depending on the size and shape of the test object 104, or a particular portion of the test object 104, the transducers 316 can be selected such that the emitted sound waves interact with the test object 104 at a particular desired angle (e.g., normal to a surface of the test object 104, or at an oblique angle to the surface of the test object 104).

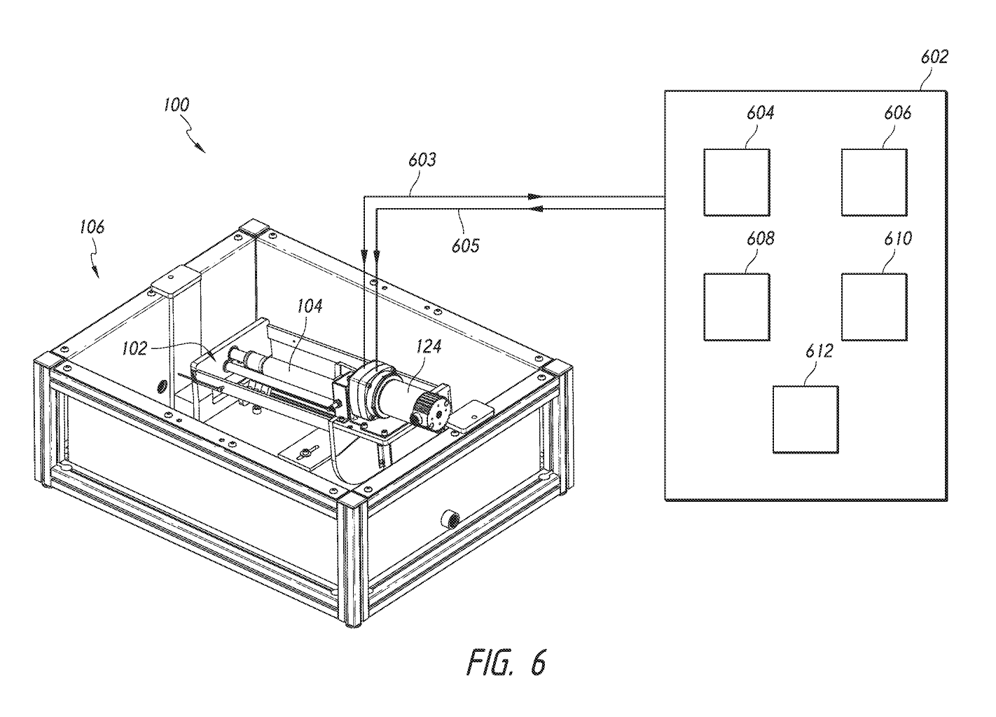

FIG. 6 is a partially schematic isometric view of the UTS 100 configured in accordance with an embodiment of the present technology. In the illustrated embodiment, the UTS 100 includes a control system 602 that is operably coupled to the test box 106 via a control cable 603 and a power cable 605. The control system 602 can include a variety of components to operate various components of the UTS 100. For example, the control system 602 can include a computer 604, a display 606 (e.g., a monitor), an input device 608 (e.g., a keyboard and/or mouse), a programmable logic controller 610, and a power supply 612. The computer 604 can include a processor, memory, integrated circuits, electronic storage devices and a variety of other components that can interface with programmable logic controller 610, the motor 124 and/or the transducers 316 to control the operation of the UTS 100. Although the control system 602 is shown schematically in FIG. 6 as being separate from the test box 106, in several embodiments, the control system 602 and/or portions of the control system 602 can be attached to or integrated into the test box 106 or components attached to the test box 106.

The control system 602 can provide power and control signals to the motor 124 and the ultrasonic arrays 102. For example, the control system 602 can actuate the motor 124 to rotate the test object 104 in one or more directions and at a variety of speeds. The control system 602 can also control the operation of the transducers 316. In several embodiments, the control system 602 can individually activate one or more transducers 316 and adjust the frequency, amplitude, and/or other characteristics of the ultrasonic sound produced by the transducers 316. The control system 602 can also receive signals from the transducers 316. In particular, ultrasonic sound generated by the transducers 316 can reflect and/or refract off of the test object 104 and return to the originating transducer 316, or to a separate transducer 316. When received at a transducer 316, the ultrasonic sound can cause the transducer to generate an electrical signal that can be delivered to the control system 602 for recording, analysis, and/or display.

Embodiments configured in accordance with the present technology can provide a variety of advantages not present in existing ultrasonic testing systems. For example, in several embodiments, the adjustable array mount 128, the arrays 102, and/or other components or features of the UTS 100 can provide for the testing of devices and components having a wide variety of shapes and sizes. In particular, although the test object 104 described above with respect to the operation of the UTS 100 is an airbag inflator tube, the UTS 100 can perform ultrasonic testing on a variety of components and devices having sizes and shapes that may differ significantly from the test object 104 (e.g., munition components, vehicle parts, and a variety of other components and devices). Importantly, the UTS 100 can rapidly change between a variety of configurations to test devices and components of varying sizes and shapes by adjusting the array mount 128, moving transducers 316, adding transducers 316, removing transducers 316, and/or swapping transducers 316 for alternative transducers 316 having differing projection axes P.

In one example of the adjustability of the UTS 100, the transducers 316 can be positioned at any desired location along the transducer supports 313 to align the transducers 316 with a component being tested or with a particular portion of the component being tested. In particular, the supports 313 of the arrays 102 extend along a majority of a length of the test box 106, and the ultrasonic arrays 102 can be quickly adjusted from a configuration with the transducers 316 positioned to test a relatively small test object, to a configuration where the transducers are aligned to test a relatively large test object. For example, with the test object 104, the uniform end portions 109 and the transition portions 107 are particularly prone to defects, and the central portion 105 of the test object 104 may not require analysis. Accordingly, in the illustrated embodiment of FIGS. 1-5B, the transducers 316 are positioned adjacent opposing ends of the arrays 102, and the transducers 316 are aligned to perform testing on the uniform end portions 109 and the transition portions 107. In other embodiments, e.g., with smaller test objects, multiple transducers can be positioned adjacent to only one end of the arrays 102. In still other embodiments, the transducers 316 can be positioned along the entire length of one or more of the arrays 102.

In another example of the adjustability of the UTS 100, the arrays 102 can be moved via the array mount 128 to a variety of positions to accommodate various test objects. In particular, referring to FIGS. 2 and 3, the horizontal guide plate 202 can be moved within the channel 214 of the base 120 to position the arrays 102 at a desired position along the first horizontal axis X, and thereby adjust the alignment of the arrays 102 with respect to the longitudinal axis L of the test object 104. Additionally, the mounting block 302 can be moved within the channel 306 of the vertical guide plate 204 to position the arrays 102 along the vertical axis Z, and thereby adjust a distance between the arrays 102 and the test object 104. Moreover, the mounting bar 210 can be moved within the channel 310 to position the arrays 102 along the second horizontal axis Y, and thereby adjust the positioning of the arrays 102 with respect to a length of the test object 104. Accordingly, movement of the horizontal guide plate 202, the mounting block 302, and the mounting bar 210 can provide for positioning on the arrays 102 along three axes. Additionally, with reference to FIG. 4, the end plates 208 can provide for adjustment of the distance between individual arrays 102 and the test object 104. Specifically, the slots 402 can provide for movement of the arrays 102 toward and away from the test object 104.

In a particular example of the adjustability of UTS 100, switching between a test object having a large diameter and a test object having a small diameter includes adjusting the array mount 128 to move the focus point of the transducers 316 to align with a diameter of the test object. In particular, the mounting block 302 can be along the vertical Z axis to adjust the focus point of the transducers 316. Similarly, the second ultrasonic array 102b can be individually adjusted along the vertical Z axis via the slots 402 to adjust the focus point of the associated transducers 316.

In addition to the adjustability provided by the array mount 128 and by the transducer supports 313 of the arrays 102, the transducers 316 can also provide for adjustability of the UTS 100. Specifically, as discussed above, the transducers 316 can be constructed to project sound waves at a variety of angles with respect to the transducer axes T (FIGS. 5A and 5B). The arrays 102 can include a variety of transducers 316 positioned to direct sound waves at different angles for different portions of a test object, and the transducers 316 can be rapidly moved or replaced to adjust the arrays 102 for particular test objects.

Some components of the UTS 100 can be at least generally similar in structure and function to components described in U.S. patent application Ser. No. 11/211,852, which is incorporated herein by reference in its entirety.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

I/we claim:

1. An ultrasonic testing system comprising:
a plurality of ultrasonic arrays, wherein the individual ultrasonic arrays include—
a transducer support extending along a length of the corresponding ultrasonic array; and
a plurality of ultrasonic transducers, wherein the individual ultrasonic transducers are mounted to the corresponding transducer support and operable to generate ultrasonic sound waves; and
an adjustable mount supporting the plurality of ultrasonic arrays, wherein the adjustable mount is operable to adjust a position of the plurality of ultrasonic arrays along at least two non-parallel axes.

2. The ultrasonic testing system of claim 1, further comprising a rotatable support configured to rotate a test object, wherein the individual ultrasonic transducers are positionable along the length of the corresponding transducer support to direct the ultrasonic sound waves at the test object.

3. The ultrasonic testing system of claim 1, further comprising a rotatable support configured to rotate a test object, wherein the test object includes multiple portions, wherein the individual transducer supports include a channel, and wherein the plurality of corresponding ultrasonic transducers can be positioned at a plurality of positions along the channel to direct the ultrasonic sound waves at desired portions of the test object.

4. The ultrasonic testing system of claim 1, further comprising a rotatable support configured to rotate a test object, wherein the adjustable mount is operable to vary a distance between individual ultrasonic transducers and the test object.

5. The ultrasonic testing system of claim 1, further comprising a rotatable support configured to rotate a test object, wherein the adjustable mount includes an array clamp having a mounting bar and a pair of end plates positioned at opposite ends of the mounting bar, wherein the individual transducer supports are mounted to the end plates, and wherein at least one of the individual transducer supports is adjustable with respect to the end plates to vary a distance between at least one ultrasonic transducer and the test object.

6. The ultrasonic testing system of claim 5, further comprising a mounting block having a channel, wherein the rotatable support rotates the test object about a longitudinal axis of the test object, wherein the longitudinal axis is oblique to a horizontal axis, and wherein the mounting bar extends through the channel along an axis parallel to the longitudinal axis.

7. The ultrasonic testing system of claim 6 wherein the mounting block is movable along a vertical axis to vary the distance between the plurality of ultrasonic transducers and the test object.

8. The ultrasonic testing system of claim 6 wherein the mounting bar is securable at a plurality of positions along the axis parallel to the longitudinal axis to adjust the position of the plurality of ultrasonic arrays with respect to the test object.

9. An ultrasonic testing system comprising:
a pair of rollers positioned to support and rotate a test object about a longitudinal axis of the test object;
an ultrasonic array including—
a transducer support having a channel; and
an ultrasonic transducer positionable along a length of the channel and operable to produce ultrasonic sound waves; and
an adjustable mount aligning the transducer support with an axis parallel to the longitudinal axis.

10. The ultrasonic testing system of claim 9 wherein the adjustable mount is operable to adjust the position of the ultrasonic array along three non-parallel axes.

11. The ultrasonic testing system of claim 9 wherein the adjustable mount includes a pair of opposing end plates having slots, wherein the transducer support is fastened to the end plates via the slots, and wherein the transducer support is mountable at a plurality of positions via the slots to vary a distance between the ultrasonic transducer and the test object.

12. The ultrasonic testing system of claim 9 wherein the ultrasonic transducer emits ultrasonic sound waves along a projection axis that is perpendicular to the longitudinal axis.

13. The ultrasonic testing system of claim 9 wherein the ultrasonic transducer emits ultrasonic sound waves along a projection axis that is oblique to the longitudinal axis.

14. The ultrasonic testing system of claim 9 wherein the longitudinal axis and the axis parallel to the longitudinal axis are oblique to a horizontal axis.

15. An ultrasonic testing system comprising:
a transducer support extending along a first axis;
an ultrasonic transducer carried by the transducer support and positionable at a plurality of positions along the first axis;
a rotatable support positioned to support and rotate a test object along a second axis parallel to the first axis; and
an adjustable mount carrying the transducer support and operable to vary a distance between the ultrasonic transducer and the test object.

16. The ultrasonic testing system of claim 15 wherein the ultrasonic transducer includes a projection axis, and wherein the adjustable mount is adjustable to vary an angle of the projection axis with respect to the test object.

17. The ultrasonic testing system of claim 15 wherein the plurality of positions along the first axis is a first plurality of positions, wherein the ultrasonic transducer is a first ultrasonic transducer having a first projection axis, wherein the ultrasonic testing system further comprises a second ultrasonic transducer carried by the transducer support, positionable at a second plurality of positions along the first axis, and having a second projection axis, and wherein, while the first ultrasonic transducer and the second ultrasonic transducer are carried by the transducer support, the first projection axis and the second projection axis are not parallel.

18. The ultrasonic testing system of claim 15 wherein the ultrasonic transducer includes a projection axis, wherein the test object includes a surface, and wherein, while the ultrasonic transducer is carried by the transducer support, the projection axis is perpendicular to the surface of the test object.

19. The ultrasonic testing system of claim 15 wherein the ultrasonic transducer includes a projection axis, and wherein the projection axis is oblique to the first axis.

20. The ultrasonic testing system of claim 15 wherein the adjustable mount is movable along at least two non-parallel axes.
